(19) United States
(12) Patent Application Publication
(10) Pub. No.: US 2024/0389214 A1
(43) Pub. Date: Nov. 21, 2024

(54) ENTANGLED PHOTON LIGHT SOURCE SYSTEMS AND METHODS

(71) Applicant: Purdue Research Foundation, West Lafayette, IN (US)

(72) Inventors: Niranjan H. Shivaram, West Lafayette, IN (US); Chris H. Greene, West Lafayette, IN (US); Yimeng Wang, Berlin (DE); Siddhant Pandey, Lafayette, IN (US)

(21) Appl. No.: 18/659,571

(22) Filed: May 9, 2024

Related U.S. Application Data
(60) Provisional application No. 63/466,781, filed on May 16, 2023.

(51) Int. Cl. H05G 2/00

(52) U.S. Cl. CPC H05G 2/008

(57) ABSTRACT

A method of generating attosecond entangled biphotons includes exciting a 1s2s ¹S₀ metastable state of a helium atom in the gas phase using four-photon absorption. The helium atoms relax by emitting extreme ultraviolet (XUV) entangled photons. The method further includes containing the helium gas in a cell at a desired high pressure, placing the cell in a vacuum chamber, collecting the emitted XUV entangled photons via an incidence toroidal mirror at a large solid angle, and collimating the XUV entangled photons into a beam.

### CROSS-REFERENCE TO RELATED APPLICATIONS

This application is related to and claims the priority benefit of U.S. Provisional Patent Application No. 63/466,781, entitled “Entangled Photon Light Source Systems and Methods,” filed May 16, 2023, the contents of which are hereby incorporated by reference in their entirety into the present disclosure.

### GOVERNMENT SUPPORT CLAUSE

This invention was made with government support under DE-SC0010545 awarded by the Department of Energy. The government has certain rights in the invention.

### TECHNICAL FIELD

The present application relates to light sources, and specifically to entangled photon light sources at extreme-ultraviolet and x-ray energies having ultrabroad bandwidth.

### BACKGROUND

Quantum entanglement is a quantum phenomenon that has no classical analog. Entanglement is at the heart of quantum information science, quantum sensing, quantum enhanced imaging and spectroscopy, and other emerging quantum technologies. Entanglement of photons has particularly played an important role in many areas of basic and applied research that leverage the quantum advantage. For example, entangled photons have been used in nonlinear spectroscopy which goes beyond the time-frequency uncertainty limit; moreover, a linear (rather than quadratic) scaling of two-photon absorption rates versus intensity is observed with entangled photons, which enhances the process at low intensities. As a light source, entangled photons can collectively excite uncoupled atoms, and lead to entanglement-induced two-photon transparency, which cannot be obtained by a classical laser source. Typical sources of entangled photons use the process of spontaneous parametric down-conversion (SPDC) in nonlinear crystals in the visible and infrared region of the spectrum. These sources generate energy-time entangled photons with correlation times on the femtosecond timescale which has been only recently directly measured. SPDC has also been demonstrated in the hard x-ray regime where the correlation times are expected to be attoseconds or smaller. Experiments using nanophotonic chips for SPDC have demonstrated entangled photon generation with broad bandwidth of 100 THz (0.41 eV) and a high generation efficiency of 13 GHz/mW.

However, improvements are needed to generate entangled photon pairs in the extreme-ultraviolet (XUV) and X-ray regimes with high photon flux and with an ultrabroad energy bandwidth (>20 eV) large enough to create correlation times on the attosecond scale.

### SUMMARY

Described herein are systems and methods related to the generation of attosecond entangled biphotons in the XUV and X-Ray regimes. To that end, methods can include exciting a 1s2s ¹S₀ metastable state of a helium atom in the gas phase using four-photon absorption, and the helium atoms can relax by emitting extreme ultraviolet (XUV) entangled photons. The method can further include containing the helium gas in a cell at a desired high pressure. The cell can include windows made of suitable material required for transmission of the XUV entangled photons. Further, the method can include placing the cell in a vacuum chamber, collecting the emitted XUV entangled photons via an incidence toroidal mirror at a large solid angle, and collimating the XUV entangled photons into a beam.

In some embodiments, methods can include forming a helium-like ion and exciting a 1s2s ¹S₀ metastable state of a helium-like ion in the gas phase using two-photon absorption. The helium-like ions can relax by emitting X-ray entangled photons. Further, the methods can include collecting the emitted X-ray entangled photons via an incidence toroidal mirror at a large solid angle and collimating the X-ray entangled photons into a beam.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 depicts a schematic diagram of entangled photon generation and absorption in a spheroidal cavity, showing the emission and absorption atoms placed at the two foci of the spheroid and the photons being reflected by the boundary of the cavity to propagate along equal length paths to reach the absorber;

FIG. 2 depicts a graphical representation of the photon correlation function [symbol] vac|ε(t₂)ε(t₁)|2ph [symbol] as a function of the time difference t₂−t₁(a.u.);

FIG. 3A depicts a schematic representation of the generation of entangled biphotons in the XUV regime via two-photon decay of the 1s2s ¹S₀ So state excited by four-photon excitation using a broadband 240-nm laser;

FIG. 3B depicts a schematic representation of the two-step sequential excitation of the 1s2s state via the 1s2p state using a high photon flux helium lamp and a 2059-nm coupling laser;

FIG. 3C depicts a schematic representation of the SCRAP technique to populate the 1s2s state using a multiphoton pump pulse and a Stark shifting pulse which enables rapid adiabatic passage and ionization suppression by LICS (LICS not shown);

FIG. 3D depicts a schematic representation of one experimental scheme to generate XUV entangled photons and utilize them in an attosecond pump-probe photoionization experiment; and

FIG. 3E depicts a schematic representation of an attosecond pump-probe photoionization scheme in molecules using entangled biphotons.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown, or the precise experimental arrangements used to arrive at the various graphical results shown in the drawings.

### DETAILED DESCRIPTION OF THE ILLUSTRATED EMBODIMENTS

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

I. Exemplary Systems and Methods for Generating Entangled Photons in the XUV and X-Ray Regimes

Described herein is a light source configured for the generation of attosecond entangled biphotons. In some examples, the light source is operable in the extreme-ultraviolet regime by two-photon decay of a metastable atomic state as a source similar to spontaneous parametric down-conversion photons. The 1s2s ¹S₀ metastable state in helium decays to the ground state by the emission of two energy-time entangled photons with a photon bandwidth equal to the total energy spacing of 20.62 eV. This can result in a pair correlation time in the attosecond regime, making these entangled photons a highly suitable source for attosecond pump-probe experiments. The biphoton generation rate from a direct four-photon excitation of helium at 240 nm is calculated and used to assess some feasible schemes to generate these biphotons. Possible applications of entangled biphotons in attosecond timescale experiments, and a discussion of their potential to reach the zeptosecond regime, are described below.

The 1s2s ¹S₀ metastable state of a helium atom, its isoelectronic ions, and the 2s ²S_{1/2} metastable state of the helium ion decay predominantly by two-photon emission. The emitted photons are energy-time entangled with a correlation time related to the energy spacing between the 2s and Is levels which is 20.62 and 40.81 eV for the helium atom and ion, respectively. Two-photon emission as a source of energy-time entangled photons has been previously studied in semiconductors where the energy bandwidth is small due to the small band gap. The large energy bandwidth of the emitted entangled photons from metastable helium and heliumlike ions corresponds to correlation times in the attosecond domain, thus opening up the possibility of attosecond timescale pump-probe experiments using these photons.

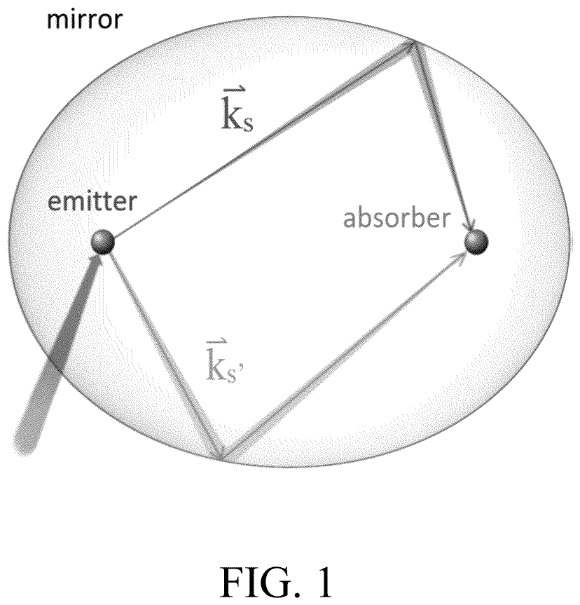

A gedanken experimental setup can first be considered in which a spheroidal cavity contains two helium atoms, with one atom placed at each of its two foci. One of the atoms is prepared in the 1s2s (¹S₀) excited state, which is used as an emitter (atom 1), and the other atom is in the 1s2 (¹S₀) ground state, which is used as an absorber (atom 2), as shown in FIG. 1. Atom 1 decays to the 1s² ground state by the simultaneous emission of two photons, according to selection rules. This decay channel dominates over the magnetic dipole transition to the 1s2s ³S₀ state. The metastable 1s2s (¹S₀) state has a long lifetime of τ=0.0197 s, and the energy gap between the 1s2s (¹S₀) and 1s² states is 20.62 eV. Thus, the two emitted photons have both a good frequency correlation and a narrow emission time difference. The biphotons should also be correlated in angular momentum, according to the angular momentum conservation rule. However, that aspect is not addressed, since inside a spheroidal cavity the entangled photon pair will be collected at the absorber after traveling along equal length paths, irrespective of their angular distribution or momenta. In treating this process, the following is assumed: (1) The cavity is large enough, that no quantization of photon frequencies or Purcell effect is relevant. (2) Both atoms are deeply trapped, so no recoil effects can be observed. (3) The mirror of the cavity is 100% reflective to all the frequencies, so no energy loss occurs during reflection of the photons. Further, it is noted that the emitted biphotons are also polarization entangled. All possible polarization configurations are considered in the calculation. The evaluations are based on a variational R-matrix calculation, which represents the atomic states as antisymmetrized products of single electron orbitals, inside an R-matrix box radius of 34 a.u. The single-electron radial basis set includes functions with up to 38 nodes, and orbital angular momenta l=0-9. The correlations between the electrons are fully accounted for in this approach.

Inside the cavity, the photon-atom interaction takes place in three stages: the population inversion of atom 1, the spontaneous two-photon emission by atom 1, and photoabsorption by atom 2. In the first stage, the singlet 1s2s state is prepared using four-photon absorption, with photons of energy h̅ω₀=5.155 eV (240.54 nm). With a monochromatic incident electric field ε₀\hat{∈} ₀ cos (ω₀t), the four-photon excitation amplitude C_{exc} is:

$${C}_{e x c} ( x ) = {( \frac{e {ε}_{0}}{2 ℏ} )}^{4} \frac{{e}^{i ( {Δ}_{eg} - 4 {ω}_{0} ) t} - 1}{{Δ}_{eg} - 4 {ω}_{0}} {D}_{eg}^{( 4 )} ,$$

$${D}_{e g}^{( 4 )} = {\sum }_{{j}_{1} , {j}_{2} , {j}_{3}} \frac{〈 e \vert \hat{ϵ} {\vert}_{0} \cdot \vec{r} \vert {\dot{j}}_{3} ) 〈 {j}_{3} \vert {\hat{ϵ}}_{0} \cdot \vec{r} \vert {j}_{2} 〉 〈 {j}_{2} \vert {\hat{ϵ}}_{0} \cdot \vec{r} \vert {j}_{1} 〉 〈 {j}_{1} \vert {\hat{ϵ}}_{0} \cdot \vec{r} \vert g 〉}{( {Δ}_{{j}_{{3}^{g}}} - 3 {ω}_{0} ) ( {Δ}_{{j}_{2} g} - 2 {ω}_{0} ) ( {Δ}_{{j}_{1} g} - {ω}_{0} )} ,$$

(“Equation 1”) where |g [symbol] is the 1s² ground and the initial state, le) is the 1s2s excited and the final state, |j_{1,2,3}) are the intermediate states, and the Δ with indices are the energy difference between them. Equation 1 is given under the electric dipole approximation, with \vec{r} representing the summed position space vectors of the two electrons, \vec{r}=\vec{r}₁+\vec{r}₂. Through the following identity:

$${lim}_{t \to ∞} \frac{{e}^{i ( {Δ}_{eg} - 4 {ω}_{0} ) t} - 1}{{Δ}_{eg} - 4 {ω}_{0}} = - 𝒫 ( \frac{1}{{Δ}_{eg} - 4 {ω}_{0}} ) + i πδ ( {Δ}_{eg} - 4 {ω}_{0} ) ,$$

the resulting unnormalized state following the excitation, which is also the initial state for the emission process, is

$$\vert γ 〉 = i π δ ( {Δ}_{e g} - 4 {ω}_{0} ) {( \frac{e {ε}_{0}}{2 ℏ} )}^{4} {D}_{e g}^{( 4 )} \vert e 〉 .$$

For a realistic laser field, the δ function can be integrated over a broadened spectrum of the laser. The photon-atom interaction for the second and third stages is

$${V}^{int} ( t ) = e \vec{r} \cdot \vec{ε} ( t ) , \vec{ε} ( t ) = {\sum }_{s} i {{\hat{ϵ}}_{s} ( \frac{2 {πℏω}_{s}}{V} )}^{\frac{1}{2}} ( {a}_{s} {e}^{i ( {\vec{k}}_{s} \cdot \vec{r} - {ω}_{s} t )} - {a}_{s}^{†} {e}^{- i ( {\vec{k}}_{s} \cdot \vec{r} - {ω}_{s} t )} ) ,$$

(“Equation 2”) where \vec{ε} is the electric field of one emitted/reabsorbed photon and V is the quantization volume. The electric field generated by a single photon is proportional to 1/√V. The photon modes s have frequency @s, propagation direction \hat{k}ₛ, and polarization direction \hat{∈}ₛ. From a second-order perturbation analysis, the amplitude of two-photon emission (|γ [symbol] ⊗|vac [symbol] →|g [symbol] ⊗|1ₛ, 1ₛ, [symbol] ) is

$${C}_{e m i}^{( s , {s}^{′} )} ( t ) = - \frac{2 π {e}^{2}}{V} \sqrt{{ω}_{s} {ω}_{s}^{′}} \frac{{e}^{i ( {ω}_{s} + {ω}_{{s}^{′}} - {Δ}_{eg} ) t} - 1}{{ω}_{s} + {ω}_{{s}^{′}} - {Δ}_{eg}} \times {\sum }_{j} \frac{〈 g \vert {\hat{ϵ}}_{{s}^{′}} \cdot \vec{r} \vert j 〉 〈 j \vert {\hat{ϵ}}_{s} \cdot \vec{r} \vert γ 〉}{ℏ ( {ω}_{s} - {Δ}_{ej} )} .$$

(“Equation 3”). |j [symbol] denotes the intermediate states for the emission process. From Equation 3 the He 1s2s (¹S₀) lifetime as τ=0.0197 s is obtained, which agrees with the experimental value. Since no singlet energy level exists between Eᵢ and Eᵢ+Δ_{eg} for atom 2, the absorption process can only start after both photons have been emitted, with ωₛ+ω_{s′}=Δ_{eg}. The modes of the photons are not detectable inside the cavity, therefore the entangled photon state is obtained by summing over all the modes (s, s′):

$$\vert 2 ph 〉 = {\sum }_{s , {s}^{′}} {C}_{emi}^{( s , {s}^{′} )} ( t \to ∞ ) \vert {1}_{s} , {1}_{{s}^{′}} 〉 .$$

(“Equation 4”). Based on a second-order perturbation calculation, the entangled photon absorption amplitude can be written as:

$${C}_{abs} ( t ) = - \frac{{e}^{2}}{{ℏ}^{2}} {\int }_{0}^{t} d {t}_{2} {\int }_{- ∞}^{t 2} d {t}_{1} {\sum }_{m} {e}^{i ( {Δ}_{mi} {t}_{1} + {Δ}_{fm} {t}_{2} )} \times ( 〈 f \vert ⊗ 〈 vac \vert ) \vec{r} \cdot \hat{ε} ( {t}_{2} ) \vert m 〉 〈 m \vert \vec{r} \cdot \vec{ε} ( {t}_{1} ) ( \vert i 〉 ⊗ \vert 2 ph 〉 ) .$$

(“Equation 5”). |i [symbol] , |m [symbol] , and |f [symbol] denote the initial, intermediate, and final states for atom 2. \vec{ε}(t_{1,2}) in Equation 5 are the electric fields of the photons that are reflected by the cavity (whose frequencies stay the same but propagation and polarization directions change), and absorbed at times t₁ and t₂, respectively. The evaluation of Equation 5 depends on the shape of the cavity; the absorption process can be described by a rank-0 tensor. The time correlation of the entangled photon pair can be found from the scalar (vac|& (t₂) ¿ (t₁) |2ph), which is proportional to the Fourier transformation of the spectrum, as:

$$〈 vac \vert ε ( {t}_{2} ) ε ( {t}_{1} ) \vert 2 ph 〉 ∝ {\int }_{0}^{{Δ}_{eg}} d {ω}_{s} {{e}^{i {ω}_{s} ( {t}_{2} - {t}_{1} )} [ {ω}_{s} ( {Δ}_{eg} - {ω}_{s} ) ]}^{3} {\sum }_{j} ( \frac{〈 g \vert r \vert j ) 〈 j \vert r \vert e 〉}{ℏ ( {ω}_{s} - {Δ}_{ej} )} + \frac{〈 g \vert r \vert j 〉 〈 j \vert r \vert e 〉}{ℏ ( {Δ}_{j g} - {ω}_{s} )} ) .$$

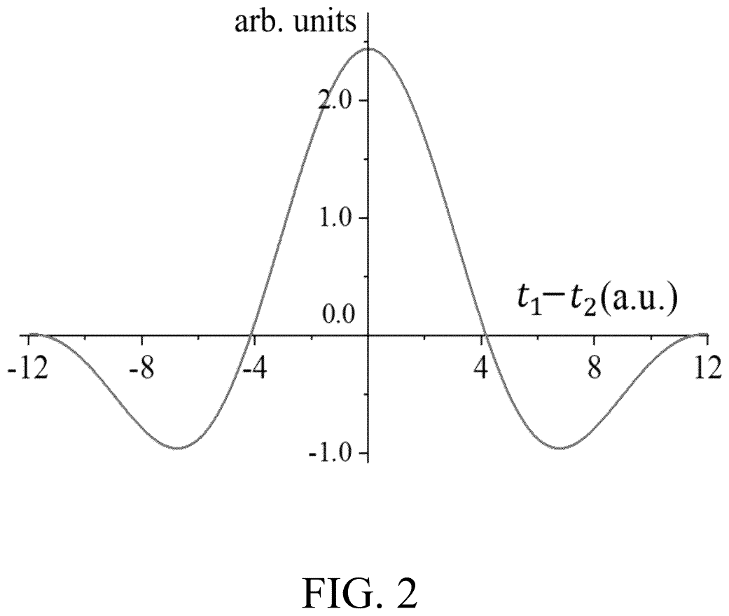

(“Equation 6”). The right-hand side of Equation 6 is plotted in FIG. 2 against the time difference between absorption events of the two photons. The timescale between the two absorption events is around ±4 a.u., which gives a correlation time around 200 attoseconds. Finally, according to Equations 1, 3, and 5, the rate of excitation, emission, and absorption, where an entangled photon pair is transferred coherently, is:

$${R}_{trans} = 2 πδ ( {Δ}_{fi} - {Δ}_{eg} ) {\vert \frac{{Θe}^{8} {ε}_{0}^{4}}{256 {ℏ}^{6} {c}^{6}} {D}_{eg}^{( 4 )} δ ( {Δ}_{eg} - 4 {ω}_{0} ) \int d {{ω}_{s} [ {ω}_{s} ( {Δ}_{eg} - {ω}_{s} ) ]}^{3} \times {\sum }_{m j} \frac{〈 f \vert r \vert m 〉 〈 m \vert r \vert i 〉}{{ω}_{s} - {Δ}_{mi}} ( \frac{〈 g \vert r \vert j 〉 〈 j \vert r \vert e 〉}{{ω}_{s} - {Δ}_{e j}} + \frac{〈 g \vert r \vert j 〉 〈 j \vert r \vert e 〉}{{Δ}_{j g} - {ω}_{s}} ) \vert}^{2} .$$

(“Equation 7”), Specifically, for a spherical cavity,

$$θ = \frac{64 {π}^{2}}{27} and {R}_{t r a n s} = 1.91 \times 10 - 25 {ε}_{0}^{8} a . u .$$

The input beam flux is

$$J = \frac{c {ε}_{0}^{2}}{8 {πℏω}_{0}} .$$

Note that the transition rate is proportional to J⁴. The entangled photon absorption rate is known to be proportional to the beam intensity (when the beam intensity is not very strong), and the result can be regarded as a generalization of this linearity. Since the excitation process involves four photons, the four-photon flux can be considered the input flux, J⁽⁴⁾=J⁴, with Rₜᵣₐₙₛ∝J ⁽⁴⁾.

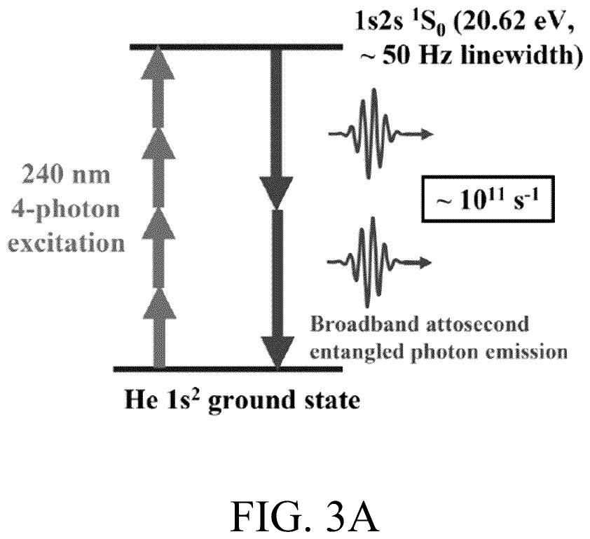

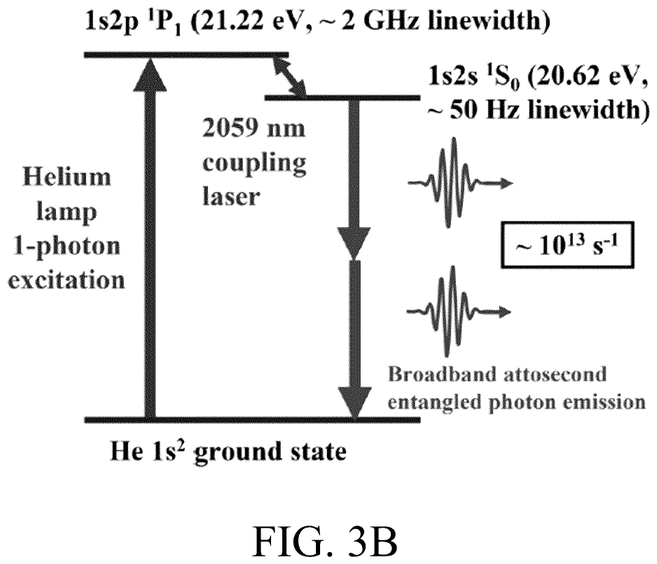

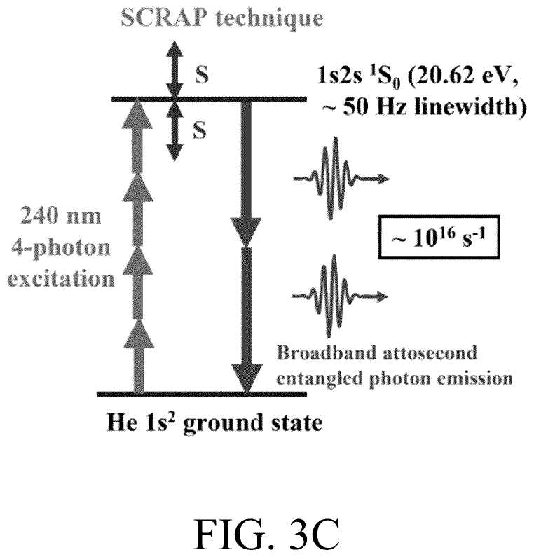

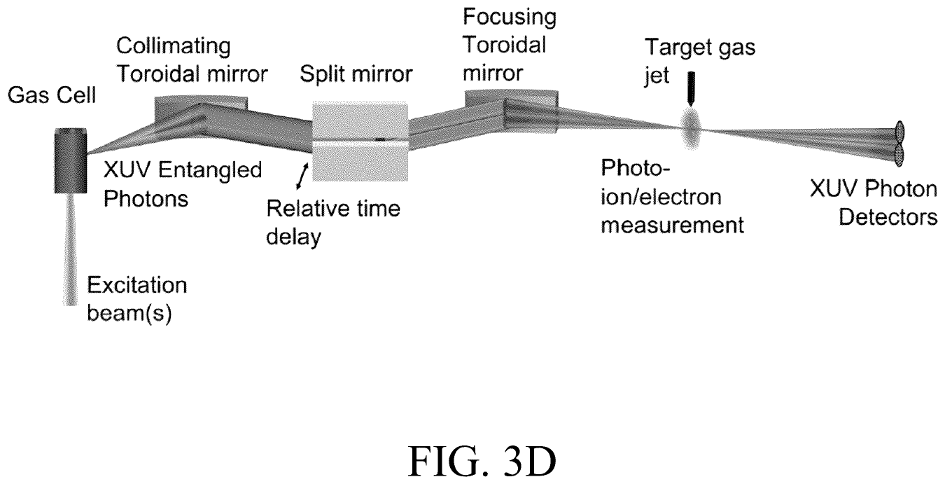

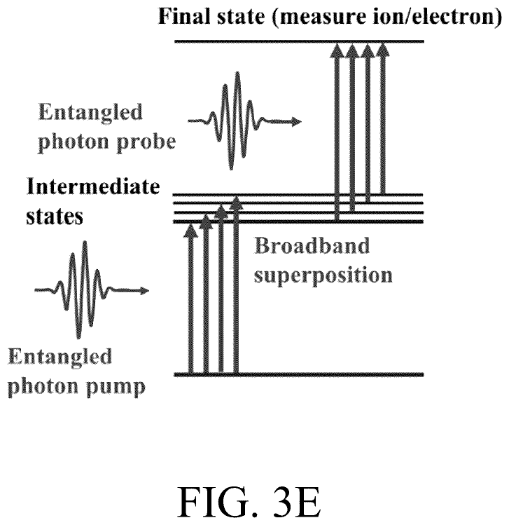

The above calculations assume a direct multiphoton excitation from 1s² to 1s2s. Since the 1s2s ¹S₀ metastable state has a narrow linewidth of ˜50 Hz, a multiphoton excitation to this state ideally includes intense lasers with a linewidth smaller than 50 Hz at a wavelength of 240 nm. While multiphoton excitations of metastable states with narrow linewidth lasers have been previously demonstrated, achieving the required high intensities with a narrow-band 240-nm laser is currently challenging. However, femtosecond lasers that can achieve peak intensities of 1014 Wcm 2 are readily available. Using the calculations for the four-photon excitation rate with a monochromatic electric field, the helium 1s2s ¹S₀ four-photon excitation rate for a femtosecond laser can be estimated. With a 240-nm femtosecond laser, with a typical bandwidth of ˜5 THz, a biphoton generation rate of ˜10¹¹ s⁻¹ (see, FIG. 3A) is obtained.

An alternative scheme using a lambda-type transition between the 1s²1, s2p, and 1s2s states could be used to achieve significant excitation. The energy levels of the latter two are 21.22 and 20.62 eV above the ground state, respectively. A two-step sequential excitation to first excite the 1s²→1s2p transition and then the 1s2p→1s2s transition could be used. The oscillator strengths for the one-photon excitation processes are f_{a→b}=2Δ_{ba}|| [symbol] b|\hat{∈}₀·\vec{r}|a [symbol] |², which gives f₁ₛ²→1s2p=0.28 and f1s2p→1s2s=−0.36 for the two steps. To achieve this two-step sequential excitation, a high photon flux helium lamp source can be used in the first step to excite 1s2p and a 2059-nm laser can transfer population to the 1s2s state (see, FIG. 3B). The ˜2 GHz linewidth of the 1s2p state makes transitions to the 1s2s state using a broadband laser more feasible in comparison to direct multiphoton excitation. Currently available helium lamp sources are capable of generating ˜10¹⁵ photons s⁻¹. Using a high-pressure helium target, nearly all of these photons could be absorbed to generate helium atoms in the 1s2p state. A high repetition rate pulsed laser source at 2059 nm could transfer nearly all these excited helium atoms to the 1s2s state. A biphoton generation rate of ˜10¹³ s⁻¹ is estimated using this method.

Another alternative approach to achieve significant population of the 1s2s singlet metastable state is to use Stark-chirped rapid adiabatic passage (SCRAP), previously proposed to excite the 2s metastable state in a hydrogen atom. In this technique, a pump pulse excites the metastable state via a multiphoton transition in the presence of a Stark pulse that Stark shifts the 1s2s state across the bandwidth of the pump pulse (see, FIG. 3C). The combined effect of the two pulses results in a Landau-Zener-type adiabatic passage that can significantly populate the 1s2s state. The SCRAP technique can also suppress ionization loss by laser-induced continuum structure (LICS). If ionization loss is ignored, for a typical femtosecond laser pulse width of 50 fs with a bandwidth of 8.8 THz, rapid adiabatic passage can excite nearly all atoms in the focal volume. When ionization loss is considered, since LICS can suppress ionization loss, it is reasonable to assume that ˜0.1% of the atoms can be excited using SCRAP for every pair of pump and Stark pulses. With ˜10¹⁴ atoms in the focal volume corresponding to a 100 μm spot size and 1 mm path length at 1 bar target pressure, this results in ˜10¹¹ atoms excited per pulse. At a femtosecond pulse repetition rate of 100 kHz currently available, this results in an entangled biphoton generation rate of 10¹⁶ s⁻¹. Among the three methods discussed here to excite helium to the singlet 1s2s state, the SCRAP method is expected to provide the highest excitation rate and hence the highest entangled biphoton generation rate.

The biphotons from the decay of the 1s2s state are emitted in all directions with an approximate distribution given by 1+cos² (θ), where θ is the relative angle between the entangled photons. The photons that are emitted in a direction orthogonal to the excitation laser propagation direction can be collected within a large solid angle and sent along independent time-delayed paths towards a pump-probe target. FIG. 3D shows a schematic of an experimental setup for the generation of these entangled photons and their utilization in an attosecond pump-probe experiment. In this scheme, a grazing incidence toroidal mirror collimates the emitted photons which are then split into two halves using a grazing incidence split mirror that introduces a controllable time delay between the two halves of the beam. Collecting biphotons emitted along the same direction within a large solid angle (as opposed to those emitted in opposite directions) ensures that no time smearing is introduced in the arrival times of the biphotons. A 10% collection solid angle will result in 1% collection of biphotons. The split beams are then focused using a second toroidal mirror onto the target gas jet. A pump-probe experiment with attosecond time resolution can be performed by measuring a photoion or photoelectron signal arising from the absorption of entangled biphotons by an atom or molecule (see, FIG. 3E). Recent work on entangled two-photon absorption sets upper bounds on the enhancements in a two-photon absorption cross section with entangled photons when no intermediate resonances are involved. Assuming a biphoton rate of ˜10¹² s⁻¹ at the pump-probe target and a two-photon cross section of 10⁻⁵⁰ cm⁴ s, a pump probe photoionization rate of ˜1000 ions per second, which is well above the detection threshold of ion spectrometers, is expected. When intermediate resonances are involved, such as broad absorption resonances in molecules typically studied in attosecond experiments, this photoionization rate can be increased by a few orders of magnitude. Further, measuring a pump-probe photoionization signal as opposed to a photon absorption signal as in previous two-photon absorption experiments allows for the detection of low absorption rates. Such entangled photon pump-probe experiments will extend the capabilities of attosecond science, where currently attosecond pulses from high-order harmonic generation (HHG) or free-electron laser sources are used.

The entangled photon generation schemes discussed here can be extended to the soft x-ray (SXR) regime using heliumlike ions. Two-photon decay in heliumlike ions has been well studied. Similar to the 1s2s ¹S₀ state of neutral helium atoms, the 1s2s ¹S₀ states of heliumlike ions such as N⁵⁺, O⁶⁺, and Ne⁸⁺, predominantly decay by two-photon emission with a rate proportional to Z⁶, where Z is the atomic number. The large energy difference between such excited states and the ground state of the ions, which can be in the range of several hundred to thousands of eV, results in entangled photon correlation times of a few attoseconds to zeptoseconds. For example, the 1s2s ¹S₀ So state of Ne⁸⁺ is located ˜915 eV above the Ne⁸⁺ ground state and this bandwidth corresponds to an entangled photon correlation time of ˜5 as. The two-photon decay rate in this case is ˜1×10⁷ s⁻¹ which is significantly larger than the corresponding rate for neutral helium atoms of ˜5×10¹ s⁻¹. Ne⁸⁺ has been previously generated using strong femtosecond laser fields as well as using strong femtosecond x-ray pulses from free-electron lasers (FELs) both of which can potentially also create Ne⁸⁺ in the 1s2s ¹S₀ excited state. In one possible scheme, strong laser field ionization could generate Ne⁸⁺ ions in the ground state and an FEL could excite them to the 1s2s ¹S₀ state by two-photon excitation which then generates highly broadband entangled biphotons at SXR energies. It has been previously demonstrated experimentally that the bandwidth required to generate few-attosecond pulses can be obtained from HHG using midinfrared pulses. Further, it has been theoretically shown that zeptosecond pulses can be generated from HHG when suitable filters are used. However, the shortest measured attosecond pulse is currently 43 attoseconds. This approach of using entangled photons from the two-photon decay of heliumlike ions offers an alternative path for carrying out ultrafast measurements in these extreme regimes of a few attoseconds to zeptoseconds.

In conclusion, an unconventional approach is presented here for generating attosecond entangled biphotons in the XUV and SXR regimes using two-photon decay in helium atoms and heliumlike ions. Multiple alternative schemes can be used to excite the 1s2s ¹S₀ metastable state in helium for which excitation rates have been estimated and an experimental scheme is suggested to collect and use the emitted XUV biphotons in attosecond pump-probe experiments. The calculated photoionization rates indicate that attosecond pump-probe experiments with entangled photons are feasible. A potential extension of such metastable excitations to heliumlike ions is additionally described, whereby SXR biphotons can be generated with entanglement times in the few-attosecond range with the possibility of reaching the zeptosecond regime. This approach can open doors to using XUV/SXR entangled photons in quantum imaging and attosecond quantum spectroscopy of atomic, molecular, and solid-state systems.

### II. Exemplary Methods of Generating Entangled Photon Pairs in the XUV Regime

### A. Direct Multiphoton Femtosecond Laser Excitation of Helium

A femtosecond laser with a wavelength of 240 nm is used to excite the 1s2s ¹S₀ metastable state of helium atoms in the gas phase via 4-photon absorption. The excited helium atoms relax by two-photon decay emitting XUV entangled photons (biphotons) with a bandwidth of 20.62 eV. The helium gas at a desired high pressure (˜5 bar) is contained in a cell with windows made of suitable material required for transmission of XUV biphotons. The cell is placed in a vacuum chamber with ˜1 millitorr or lower pressure to prevent absorption of emitted biphotons by air.

The biphotons are emitted in all directions from the excited metastable helium gas. A large area grazing incidence toroidal mirror collects emitted biphotons in a large solid angle and collimates them into a beam of biphotons.

### B. Multiphoton Femtosecond Laser Excitation of Helium with Stark-Chirped Rapid Adiabatic Passage (SCRAP)

A femtosecond laser with a wavelength of 240 nm is used to excite the 1s2s ¹S₀ metastable state of helium atoms in the gas phase via 4-photon absorption in the presence of a second laser pulse that increases rate of excitation by Stark-Chirped Rapid Adiabatic Passage (SCRAP). This second laser pulse is of suitable wavelength such as 800 nm, has significantly longer pulse duration (˜1 picosecond) compared to the 240 nm pulse (˜50 femtosecond) and has high enough intensity (˜10¹³ W/cm²) to Stark shift the metastable state. The excited helium atoms relax by two-photon decay emitting XUV biphotons with a bandwidth of 20.62 eV. The helium gas at a desired high pressure (˜5 bar) is contained in a cell with windows made of suitable material required for transmission of XUV biphotons. The cell is placed in a vacuum chamber with ˜ 1 millitorr or lower pressure to prevent absorption of emitted biphotons by air.

The biphotons are emitted in all directions from the excited metastable helium gas. A large area grazing incidence toroidal mirror collects emitted biphotons in a large solid angle and collimates them into a beam of biphotons.

### III. Exemplary Methods of Generating Entangled Photon Pairs in the X-Ray Regime

### A. Strong Field Femtosecond Laser Generation and X-ray Free Electron Laser Excitation of Helium-Like Ions

A strong field femtosecond laser with wavelength of 800 nm (or similar) and intensity of ˜10¹⁷ W/cm² is used to create helium-like ions such as Ne⁸⁺, O⁶⁺, or N⁵⁺ or any other helium-like ion created in the gas phase by strong field laser ionization of a gas jet of Neon, Oxygen, Nitrogen or any other suitable atom in a vacuum chamber with a pressure of ˜1×10⁻⁶ Torr or lower. A femtosecond pulse of suitable photon energy from an X-ray Free Electron Laser (XFEL) is used to excite the 1s2s ¹S₀ metastable state of helium-like ions by two-photon absorption. The excited metastable helium-like ions relax by two-photon decay emitting X-ray biphotons with a bandwidth corresponding to the difference in energy between the 1s2s ¹S₀ metastable state and the ground state of the helium-like ion.

The biphotons are emitted in all directions from the excited metastable helium-like ions. A large area grazing incidence toroidal mirror collects emitted biphotons in a large solid angle and collimates them into a beam of biphotons.

### B. X-ray Free Electron Laser Generation and Excitation of Helium-

Like Ions

A femtosecond XFEL pulse with photon energy of ˜1000 eV (or similar) and intensity of ˜ 10¹⁷ W/cm² is used to create helium-like ions such as Ne⁸⁺, O⁶⁺, or N⁵⁺ or any other helium-like ion created in the gas phase by ionization of a gas jet of Neon, Oxygen, Nitrogen or any other suitable atom in a vacuum chamber with a pressure of ˜ 1×10⁻⁶ Torr or lower. A second femtosecond pulse also from the XFEL with a suitable photon energy is used to excite the 1s2s So metastable state of helium-like ions by two-photon absorption. The excited metastable helium-like ions relax by two-photon decay emitting X-ray biphotons with a bandwidth corresponding to the difference in energy between the 1s2s ¹S₀ metastable state and the ground state of the helium-like ion.

The biphotons are emitted in all directions from the excited metastable helium-like ions. A large area grazing incidence toroidal mirror collects emitted biphotons in a large solid angle and collimates them into a beam of biphotons.

Reference systems that may be used herein can refer generally to various directions (for example, upper, lower, forward and rearward), which are merely offered to assist the reader in understanding the various embodiments of the disclosure and are not to be interpreted as limiting. Other reference systems may be used to describe various embodiments, such as those where directions are referenced to the portions of the device, for example, toward or away from a particular element, or in relations to the structure generally (for example, inwardly or outwardly).

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

I/we claim:

1. A method, comprising:
(a) exciting a 1s2s ¹S₀ metastable state of helium atoms in a gas phase using four-photon absorption, wherein the helium atoms relax by emitting extreme ultraviolet (XUV) entangled photons;
(b) containing the helium gas in a cell at a predetermined pressure, wherein the cell includes windows made of suitable material required for transmission of the XUV entangled photons;
(c) placing the cell in a vacuum chamber;
(d) collecting the emitted XUV entangled photons via an incidence toroidal mirror at a large solid angle; and
(e) collimating the XUV entangled photons into a beam.

2. The method of claim 1, wherein exciting the 1s2s ¹S₀ metastable state of the helium atom includes activating a first femtosecond laser with a 240-nanometer wavelength.

3. The method of claim 1, wherein exciting the 1s2s ¹S₀ metastable state of the helium atom includes activating a first femtosecond laser pulse with a 240-nanometer wavelength in the presence of a second femtosecond laser pulse that increases rate of excitation by Stark-Chirped Rapid Adiabatic Passage (SCRAP).

4. The method of claim 3, wherein the second femtosecond laser pulse includes an 800-nanometer wavelength.

5. The method of claim 1, wherein the XUV entangled photons include a bandwidth of 20.62 eV.

6. The method of claim 4, wherein the predetermined pressure is 5 bar.

7. The method of claim 1, further comprising adjusting a pressure within the vacuum chamber to 1 millitorr or lower.

8. A method, comprising:
(a) forming a helium-like ion;
(b) exciting a 1s2s ¹S₀ metastable state of the helium-like ion using two-photon absorption, wherein the helium-like ions relax by emitting X-ray entangled photons;
(c) collecting the emitted X-ray entangled photons via an incidence toroidal mirror at a large solid angle; and
(d) collimating the X-ray entangled photons into a beam.

9. The method of claim 8, wherein the helium-like ion includes a helium-like ion created in a gas phase.

10. The method of claim 8, wherein the helium-like ion includes one of Ne⁸⁺, O⁶⁺, N⁵⁺ or any other helium-like ion.

11. The method of claim 8, wherein forming a helium-like ion includes directing a femtosecond laser pulse toward a gas jet of one of Neon, Oxygen, Nitrogen or any other suitable atom in a vacuum chamber.

12. The method of claim 11, wherein the femtosecond laser pulse includes a wavelength of 800 nanometers and an intensity of 10¹⁷ W/cm².

13. The method of claim 11, wherein the femtosecond laser pulse includes a XFEL pulse with a photon energy of about 1000 eV and intensity of 10¹⁷ W/cm².

14. A method, comprising:
(a) exciting a 1s2s ¹S₀ metastable state of helium atoms in a gas phase by activating a first femtosecond laser, wherein the helium atoms relax by emitting extreme ultraviolet (XUV) entangled photons;
(b) containing the helium gas in a cell at a predetermined pressure;
(c) placing the cell in a vacuum chamber;
(d) collecting the emitted XUV entangled photons; and
(e) collimating the XUV entangled photons into a beam.

15. The method of claim 14, wherein the cell includes windows made of suitable material required for transmission of the XUV entangled photons.

16. The method of claim 14, wherein the first femtosecond laser includes a 240-nanometer wavelength.

17. The method of claim 14, wherein exciting the 1s2s ¹S₀ metastable state of the helium atom includes activating the first femtosecond laser in the presence of a second femtosecond laser.

18. The method of claim 17, wherein the first femtosecond laser is configured to output a 240-nanometer wavelength pulse and the second femtosecond laser is configured to output an 800-nanometer wavelength pulse.

19. The method of claim 14, wherein the predetermined pressure is 5 bar.

20. The method of claim 14, further comprising adjusting a pressure within the vacuum chamber to 1 millitorr or lower.
